(19) United States
(12) Patent Application Publication
(10) Pub. No.: US 2004/0205003 A1
(43) Pub. Date: Oct. 14, 2004

(54) Method of selling a virtual bundle of items to consumers

(76) Inventors: Paul E. Carpenter, Mason, OH (US); Joseph P. Balbo, Cincinnati, OH (US)

Correspondence Address: HASSE GUTTAG & NESBITT LLC, 7550 CENTRAL PARK BLVD., MASON, OH, 45040, US

(21) Appl. No.: 10/824,160

(22) Filed: Apr. 14, 2004

Related U.S. Application Data
(60) Provisional application No. 60/462,763, filed on Apr. 14, 2003.

(51) Int. Cl. G06F 17/60

(52) U.S. Cl. 705/26

(57) ABSTRACT

The invention relates to a method of selling a virtual bundle of items to a consumer at retail. The method comprises the steps of providing information from a first vendor to a second vendor about items available for offering by the second vendor to the consumer for purchase as a virtual bundle of items; providing information from the first vendor about an incentive offered to the second vendor based on the virtual bundle of items purchased by the consumer; communicating an offer by the second vendor to a consumer for the purchase at retail of a virtual bundle of items; allowing the consumer to create and purchase a virtual bundle of items; providing information about the virtual bundle purchased; and providing an incentive from the first vendor to the second vendor based on the virtual bundle of items purchased. Also disclosed are a computer system and a computer program product for use in practicing the method.

### CROSS-REFERENCE TO RELATED APPLICATIONS

This application claims the benefit of co-pending U.S. Provisional Patent Application No. 60/462,763, filed Apr. 14, 2003.

### TECHNICAL FIELD

The present invention relates to a method of selling items (i.e., any products, services, and combinations thereof) to a consumer at retail. More particularly, the present invention relates to a method for selling a virtual bundle of items available from a first vendor through a second vendor, wherein the consumer creates and purchases at retail the virtual bundle of items, and the first vendor provides an incentive to the second vendor based on the virtual bundle purchased by the consumer. As used herein, the term “virtual bundle” refers to items that are purchased by a consumer in a retail outlet as if they are physically bundled together even though they are not.

### BACKGROUND OF THE INVENTION

Manufacturers of products have offered special pack, bundle pack, on-pack and co-pack programs for many years. These conventional special pack programs typically feature two or more products co-packed or physically bundled together at retail for a specific promotional time period, usually with an incentive to the consumer to buy featured products. The process usually begins with the creation of an idea outlining which products the manufacturer believes will sell well together at retail. The products are often complimentary and/or are designed to induce a trial of a new or different product. Once the idea is approved within the manufacturer, a new identification code is assigned to the special pack. Special packaging is designed, printed and shipped to a co-packer for the products. The featured products are manufactured and sent from the plant to the co-packer. After the product is co-packed, it is typically shipped to a warehouse for storage until the featured special pack is sold into retail. Participating customers (i.e., retailers) are then shipped the special pack product for display at their stores. Consumers who shop at participating stores will either purchase the special pack or not purchase it. The consumers usually do not have the option of selecting other products to include in the special pack or creating their own custom-designed special pack. If they want to take advantage of the special pack offer, they must accept the items pre-selected in the special pack offer. At the end of the special pack promotional time period, any remaining unsold special packs are typically sold at retail at a reduced price or picked up by a vendor and returned to the manufacturer's warehouse. The unsold product may be scrapped or sold off to a liquidator at a loss, or it may be unpacked and redistributed, at additional expense to the owner, as traditional inventory. Such special pack programs can be inefficient due to the high cost of producing and packaging the bundled items, poor sell in at retail, limited purchase by consumers, and losses associated with scrapping unsold inventory.

Thus, there is a continuing need for an improved method for selling a bundle of items to a consumer at retail that provides the consumer with the opportunity to select desired items for inclusion in the bundle. Such a method could reduce the volume of unsold pre-bundled items and the overall cost of the promotional program. The method could also increase sales to consumers by offering them the opportunity to select and purchase a virtual bundle of desired items instead of a pre-selected bundle of items.

### SUMMARY OF THE INVENTION

The present invention relates to a method of selling a virtual bundle of items to a consumer at retail, said method comprising the steps of:

a. providing information from a first vendor to a second vendor about items available from the first vendor that are available for inclusion within items offered by the second vendor to a consumer for purchase at retail as a virtual bundle of items;

b. providing information from the first vendor to the second vendor about an incentive offered by the first vendor to the second vendor based on the virtual bundle of items purchased by the consumer;

c. communicating an offer by the second vendor to a consumer for the purchase at retail of a virtual bundle of items from those items available for inclusion within the virtual bundle;

d. allowing the consumer to create and purchase at retail a virtual bundle of items from those items available for inclusion within the virtual bundle;

e. providing information about the virtual bundle of items purchased by the consumer to the first vendor and the second vendor; and

f. providing an incentive from the first vendor to the second vendor based on the virtual bundle of items purchased by the consumer.

In one aspect, the invention relates to such a method further comprising the step of giving the consumer an incentive for purchasing the virtual bundle of items.

The invention also relates to a computer system and a computer program product for use in practicing the methods of the invention.

### BRIEF DESCRIPTION OF THE DRAWINGS

FIG. 1 is a flow diagram of a method according to one embodiment of the invention.

FIG. 2 is an illustration of a computer screen wherein a manufacturer may enter information regarding items available for inclusion within items offered by a second vendor to a consumer for purchase at retail as a virtual bundle according to a method of the invention.

### DETAILED DESCRIPTION OF THE INVENTION

In one embodiment, the method of the invention is referred to as a Virtual Special Pack (VSP) process. The VSP process is designed to remove the excessive expense of conventional special pack programs. The process also provides an opportunity for manufacturers and their customers to increase sales by effectively offering consumers the ability to create and purchase at retail (i.e., in a physical establishment, as distinguished from an on-line purchase via the internet) their own “virtually” bundled products. Moreover, the process is designed to offer incentives to customers based on the number or value of the virtual bundles purchased by consumers. Some or all of these incentives may be passed on to consumers in the form of lower prices for products.

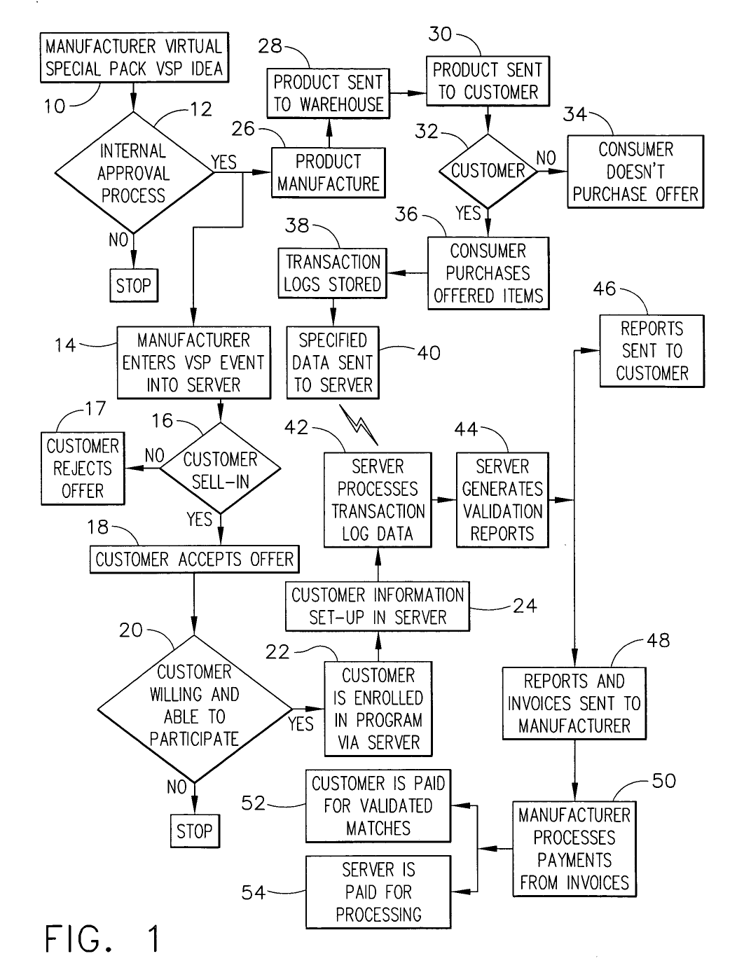

As shown in FIG. 1, the VSP process typically begins with a first vendor, e.g., a distributor or a manufacturer, creating an idea or concept of the products it believes will sell well together at retail (referred to as the VSP event), as shown in step 10. Alternatively, a customer or an agent (such as an advertising agency or consultant) of the manufacturer, distributor, or customer, or a consumer may suggest the VSP event to the manufacturer.

Once the VSP event completes the manufacturer's internal approval process, as shown at step 12, the manufacturer typically creates the event and enters information about the event in a computer server, as shown in step 14. This information may include a listing of the items available from the manufacturer that are available for inclusion within the items offered by a second vendor, such as a customer or retailer, to a consumer for purchase as a virtual bundle of items. The server typically has multiple levels of security to ensure that only authorized users of the manufacturer can see only the offers created by the manufacturer. The system also allows for multiple levels of security within other parties such as a second vendor (e.g., a customer or retailer) given access to the VSP event information, including read only access, read/write access, as well as provisions for sign-offs before a particular event is activated.

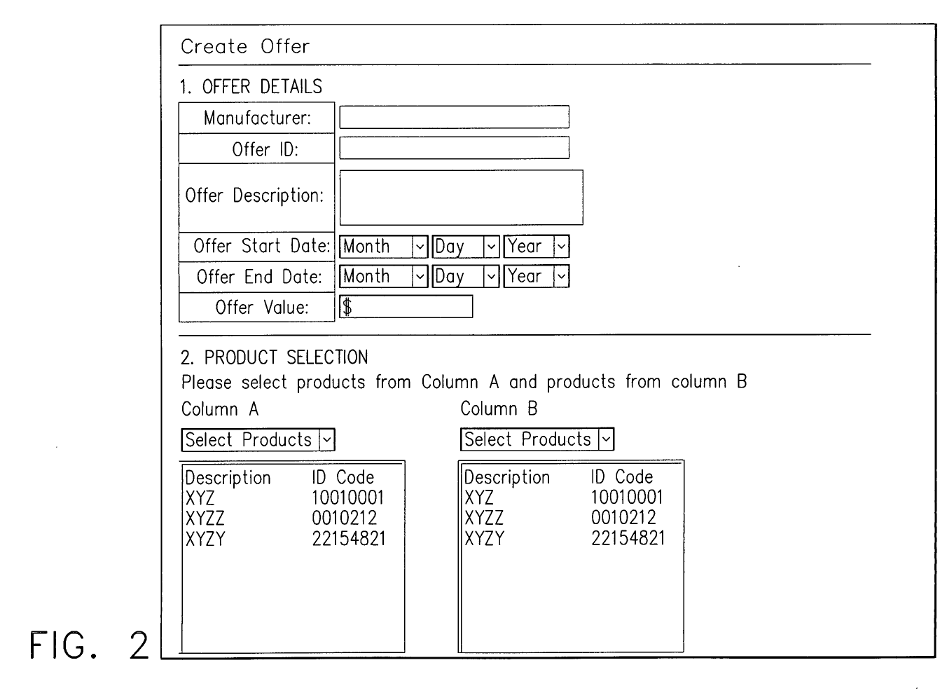

Each VSP event may feature an offering of two or more families of products featured in a menu format within the server. FIG. 2 is an illustration of a computer screen wherein a manufacturer enters information regarding an offer to be made to a second vendor to participate in a VSP event. The manufacturer typically enters its identification information, the event name, information describing the event, the start and end dates of the overall promotion, the length of time any one customer may run the promotion, and the value of the event to the customer, and any relevant information about the VSP event. The interface then allows the manufacturer to select the products that can be grouped together for the event. For example, the manufacturer may pick items from columns A or B (or any number of additional columns, e.g., three, four, or more columns) based on the number of item groupings for the given event. These items can be individual products or services, or families of products or services, provided that the families are related with a common family identification code. This flexibility to choose multiple items or families of items in the VSP event provides an additional advantage for the invention over conventional special pack programs. The server menu typically displays the VSP event via electronic format to the manufacturer's team responsible for the event.

Information from the first vendor (e.g., a manufacturer) about the VSP event is then provided to a second vendor (e.g., a customer of the manufacturer). This may be done by providing the second vendor with access to the VSP event information in the server. The manufacturer or its representative may use the information as a sell-in vehicle to a second vendor, such as a customer or retailer, as shown in step 16. The information provided to the second vendor includes information about items available from the first vendor that are available for inclusion within items offered by the second vendor to a consumer for purchase at retail as a virtual bundle of items. Also included is information from the first vendor to the second vendor about an incentive offered by the first vendor to the second vendor based on the virtual bundle of items purchased by the consumer. In one embodiment, the customer is offered the opportunity to participate in the VSP event and gain a financial incentive based on the performance of the VSP products at its retail locations. The customer may choose to participate in the VSP event and accept the offer, as shown in step 18, or it may reject the offer and not participate in the VSP event, as shown in step 17.

A customer who chooses to participate in the VSP event first confirms via the server that it is willing and able to participate in the event, as shown in step 20. The customer is typically expected to collect, store and send transaction log (Tlog) data to the server. Once a customer confirms his desire and ability to participate, the customer is enrolled in the event via the server, as shown in step 22. The enrollment process typically includes establishing who from the customer has authority to select the events in which the customer will participate, and who has authority to approve participation. The customer also enters information in the server to set up the VSP event, as shown in step 24. For example, the customer may select a promotional time period for the VSP event to run in its store, as bound by the parameters established by the manufacturer. The customer also selects products from the featured VSP event products listed in the server menu that it will offer to consumers for purchase as a virtual bundle of products. The products selected are identified by unique identification codes on the products (e.g., UPC codes). The information inputted allows the server to process transaction log data regarding a consumer's purchase at retail of a virtual bundle of items, as shown in step 42.

Separately, the manufacturer or its agent manufactures the products that will be offered by the customer to consumers for purchase at retail as a virtual bundle, as shown in step 26. These items may have been manufactured earlier for sale as separate products, or they may be manufactured specifically for the VSP event. The products are typically sent to a warehouse for temporary storage, as shown in step 28. At an appropriate time, the products are sent to the customer's retail store, as shown in step 30.

The customer then communicates an offer to at least one consumer, but often to a predetermined group of consumers (e.g., those shopping in a certain area of the store or buying a particular product) or to all consumers entering its store, for the purchase at retail of a virtual bundle of items from those items available for inclusion with the virtual bundle, as shown in step 32. This is often accomplished through the use of in-store advertising, which may be supplemented by media or print advertising. Unlike conventional programs that pre-bundle the items, the consumer is allowed to create and purchase at retail a virtual bundle of items from the items available for inclusion with the virtual bundle. The consumer may decide not to purchase a virtual bundle of items, as shown in step 34, or the consumer may purchase a virtual bundle of items, as shown in step 36. The consumer may be given a discount or other incentive for purchasing a virtual bundle of items. For example, the consumer may purchase a particular size and any fragrance of a manufacturer's shampoo and hair conditioner, and receive a price reduction at the register or some other incentive such as a free product. As another example, a consumer may purchase any flavor of a featured twelve-pack of a soft drink and any variety of a featured bag of chips and receive a free lunch bag. In another example, a consumer may purchase any flavor of featured toothpaste, toothbrush and dental floss and receive a price reduction at the register.

Based on products selected for the VSP event, the second vendor or customer will receive a financial incentive (determined by the first vendor) each time a consumer purchases a virtual bundle of featured products during the promotional time period, but typically only when the purchase is made in a single market basket transaction. A market basket transaction is usually considered to be all items purchased by a consumer and paid for in one financial transaction. If the consumer selects and pays for one featured product, leaves the register and then returns and purchases a second featured product at a different time with a different financial exchange, it is usually considered to be two separate market baskets that would not qualify for the incentive. A portion of the incentive earned by the second vendor, or all of the incentive, may be passed on to the consumer, e.g., in the form of a discount on the items purchased by the consumer.

The market basket data, also referred to as the transaction log (Tlog) data, are collected and stored, as shown in step 38, usually by the customer. Relevant Tlog data are sent to the server, as shown in step 40, for processing. The server processes the Tlog data, as shown in step 42, and provides any necessary validation. The server typically processes data for valid matches of unique identifying codes from products featured as part of the VSP event, based on the parameters established by the manufacturer. Matches are tabulated and the server generates validation reports comprising information about the virtual bundle of items purchased by the consumer, as shown in step 44. The reports are then provided to the customer, as shown in step 46, and the manufacturer, as shown in step 48. For example, the customer may be sent a report highlighting the number of valid transactions. The manufacturer may also be sent a report for each participating customer highlighting the total number of valid matches. The server may also generate reports for the manufacturer to pay each customer who participated in the event an incentive based on the virtual bundle of items purchased by consumers from the customer. The manufacturer processes payments from invoices based on these reports, as shown in step 50. The customer is paid an incentive for validated matches based on the virtual bundle of items purchased by its consumers, as shown in step 52. The manufacturer typically distributes payments to the customer via an agreed upon method. The server may also generate a processing fee invoice for the manufacturer to pay (e.g., the server or its operator or provider) for the service provided, as shown in step 54.

The method of the invention may further comprise the step of establishing an internet connection with the server for the second vendor to view and select items available for inclusion within the items offered by the second vendor to a consumer for purchase as a virtual bundle of items. The internet connection may be established with a computer system at a remote location from the server. In one method, information about the items purchased by the consumer as a virtual bundle of items is collected, stored and transferred to the first vendor and/or the second vendor for processing and validation. Such information is typically posted and processed on a server accessible to the first vendor and the second vendor. Reports comprising information about the virtual bundle of items purchased by the consumer are typically generated and provided to the first vendor and the second vendor.

While the above process has been described using a computer server, it will be appreciated that a server is not necessary to practice the invention. One or more steps of the invention may be accomplished through the use of written and/or oral communications. However, in one embodiment, the method of the invention is performed at least in part using a computer system cooperating with one or more users who access, enter information in, and receive outputs from, the computer system. The system may be implemented in the framework of a cooperative computer support network in which users initiate certain actions and make decisions using information that has been processed by a computer. The various components of the system are interconnected with each other (for example, they are in communication with each other via an electronic analog or digital, infrared or other similar transmission), typically via a host computer which may be any type of digital or other computing apparatus, such as a main frame, server or mini-computer. The host computer typically coordinates, organizes and relays information to and from other components of the system.

In one aspect of the invention, a computer system is provided for posting information about items available from a first vendor that are available for inclusion within items to be offered by a second vendor to a consumer for purchase at retail as a virtual bundle of items. The system includes means for posting information about the items available from the first vendor for review by the second vendor, and means for posting information about an incentive offered by the first vendor to the second vendor based on the virtual bundle of items purchased by the consumer. The system for posting the information further includes means for enrolling the second vendor after the second vendor confirms a willingness and ability to participate in the method of the invention. The means for posting information is included within the server on which information about the available items is stored. A connection is established with a computer system and the server to accomplish the above steps. The connection is typically established between the computer system and the server over the internet. The system typically also includes an interface circuit configured to establish a connection with a remote computer system and the server coupled to the interface circuit.

A computer system according to one embodiment of the invention may comprise a controller that includes an internet server, a first vendor access system, a second vendor access system, and a tracking system. The first vendor access system is coupled to the internet server and to the tracking system to control communications between the controller and a first vendor accessing the system. The first vendor accesses the controller to view, select and review products/services over the internet. The first vendor may an individual, group of individuals, association, corporation, or any other person or entity accessing the system to review and select items that are available from (or through) the first vendor that are available for inclusion within items that may be offered by a second vendor to a consumer for purchase at retail as a virtual bundle of items. The first vendor is typically registered with the system of the invention. Alternatively, the first vendor is any user or group of users accessing the system of the invention.

The second vendor access system is coupled to the internet server and to the tracking system to control communications between the controller and a second vendor accessing the system. The second vendor accesses the controller to view, select and review products/services for inclusion within items offered to a consumer for purchase at retail as a virtual bundle of items. The second vendor may be an individual or groups of manufacturers, resellers, retailers, owners, service providers, and any other person or entity accessing the system. The first and second vendors access the tracking system to receive and validate data and/or reports regarding a virtual bundle of items purchased by a consumer, and to receive and/or process invoices and payments based on the virtual bundle of items purchased by a consumer.

Thus, another embodiment of the invention relates to a computer system for use in selling a virtual bundle of items to a consumer at retail, said system comprising:

a. means for posting information about an offer from a first vendor to provide items that are available for inclusion within items to be offered by a second vendor to a consumer for purchase at retail as a virtual bundle of items;

b. means for posting information from the first vendor about an incentive offered by the first vendor to the second vendor based on the virtual bundle of items purchased by the consumer;

c. means for the second vendor to accept the offer from the first vendor to offer items available from the first vendor to a consumer for purchase at retail as a virtual bundle of items;

d. means for storing, processing and validating information about the virtual bundle of items purchased by the consumer;

e. means for reporting information to the first vendor and the second vendor about the virtual bundle of items purchased by the consumer; and

f. means for reporting information about the incentive to be paid by the first vendor to the second vendor based on the virtual bundle of items purchased by the consumer.

The present invention also relates to a computer program product storing instructions therein for instructing a computer to perform a method comprising the steps of: (a) providing information from a first vendor to a second vendor about items available from the first vendor that are available for inclusion within items offered by the second vendor to a consumer for purchase at retail as a virtual bundle of items; (b) providing information from the first vendor to the second vendor about an incentive offered by the first vendor to the second vendor based on the virtual bundle of items purchased by the consumer; (c) providing information about the virtual bundle of items purchased by the consumer to the first vendor and the second vendor; and (d) providing an incentive from the first vendor to the second vendor based on the virtual bundle of items purchased by the consumer; said computer program product comprising a recording medium readable by the computer and instructions stored on the recording medium instructing the computer to perform the steps (a)-(d).

The invention has been described in terms of specific embodiments incorporating details to facilitate the understanding of principles of operation of the invention. Such specific embodiments and details are not intended to limit the scope of the claims appended hereto. It will be apparent to those skilled in the art that modifications may be made in the embodiment without departing from the spirit and scope of the invention.

What is claimed is:

1. A method of selling a virtual bundle of items to a consumer at retail, said method comprising the steps of:
a. providing information from a first vendor to a second vendor about items available from the first vendor that are available for inclusion within items offered by the second vendor to a consumer for purchase at retail as a virtual bundle of items;
b. providing information from the first vendor to the second vendor about an incentive offered by the first vendor to the second vendor based on the virtual bundle of items purchased by the consumer;
c. communicating an offer by the second vendor to a consumer for the purchase at retail of a virtual bundle of items from those items available for inclusion within the virtual bundle;
d. allowing the consumer to create and purchase at retail a virtual bundle of items from those items available for inclusion within the virtual bundle;
e. providing information about the virtual bundle of items purchased by the consumer to the first vendor and the second vendor; and
f. providing an incentive from the first vendor to the second vendor based on the virtual bundle of items purchased by the consumer.

2. The method of claim 1 wherein the first vendor is the manufacturer of the items available for inclusion within the virtual bundle of items.

3. The method of claim 2 wherein the second vendor is a customer of the manufacturer.

4. The method of claim 1 wherein the items are identified by a unique identification code.

5. The method of claim 4 wherein the items are products, services, or combinations thereof.

6. The method of claim 1 wherein the offer by the second vendor to the consumer is communicated through in-store advertising.

7. The method of claim 1 wherein the consumer is given an incentive for purchasing the virtual bundle of items.

8. The method of claim 1 wherein the second vendor receives a financial incentive each time a consumer purchases a virtual bundle of items in a single market basket transaction.

9. The method of claim 1 wherein information about the items available from the first vendor for inclusion in a virtual bundle is posted on a server.

10. The method of claim 9 further comprising the step of establishing an internet connection with the server for the second vendor to view and select the items available for inclusion within the items offered to a consumer for purchase as a virtual bundle of items.

11. The method of claim 10 wherein the second vendor receives a financial incentive each time a consumer purchases a virtual bundle of items in a single market basket transaction.

12. The method of claim 11 wherein information about the market basket transaction is collected, stored and transferred for processing and validation.

13. The method of claim 12 wherein the information is processed on a server.

14. The method of claim 13 wherein reports comprising information about the virtual bundle of items purchased by the consumer are generated and provided to the first vendor and the second vendor.

15. A method of selling a virtual bundle of items to a consumer at retail, said method comprising the steps of:
a. providing information from a first vendor to a second vendor about items available from the first vendor that are available for inclusion within items offered by the second vendor to a consumer for purchase at retail as a virtual bundle of items;
b. providing information from the first vendor to the second vendor about a financial incentive offered by the first vendor to the second vendor based on the virtual bundle of items purchased by the consumer;
c. communicating an offer by the second vendor to a consumer through the use of in-store advertising for the purchase at retail of a virtual bundle of items from those items available for inclusion within the virtual bundle;
d. allowing the consumer to create and purchase at retail a virtual bundle of items from those items available for inclusion within the virtual bundle;
e. giving the consumer an incentive for purchasing the virtual bundle of items;
f. providing information about the virtual bundle of items purchased by the consumer to the first vendor and the second vendor; and
g. providing a financial incentive from the first vendor to the second vendor based on the virtual bundle of items purchased by the consumer.

16. The method of claim 15 wherein the first vendor is the manufacturer of the items available for inclusion in the virtual bundle of items.

17. The method of claim 16 wherein the second vendor and the consumer receive a financial incentive each time the consumer purchases a virtual bundle of items in a single market basket transaction.

18. The method of claim 17 wherein information about the virtual bundle of items is posted on a server.

19. The method of claim 18 further comprising the step of establishing an internet connection with the server for the second vendor to view and select the items available for inclusion within the items offered to a consumer for purchase as a virtual bundle of items.

20. A computer system for use in selling a virtual bundle of items to a consumer at retail, said system comprising:
a. means for posting information about an offer from a first vendor to provide items that are available for inclusion within items to be offered by a second vendor to a consumer for purchase at retail as a virtual bundle of items;
b. means for posting information from the first vendor about an incentive offered by the first vendor to the second vendor based on the virtual bundle of items purchased by the consumer;
c. means for the second vendor to accept the offer from the first vendor to offer items available from the first vendor to a consumer for purchase at retail as a virtual bundle of items;
d. means for storing, processing and validating information about the virtual bundle of items purchased by the consumer;
e. means for reporting information to the first vendor and the second vendor about the virtual bundle of items purchased by the consumer; and
f. means for reporting information about the incentive to be paid by the first vendor to the second vendor based on the virtual bundle of items purchased by the consumer.

21. The system of claim 20 further comprising an interface circuit configured to establish a connection with a remote computer system.

22. The system of claim 21 wherein the means for posting information is included within a server on which information about the available items is stored.

23. The system of claim 22 wherein a connection is established between the remote computer system and the server to view, select and accept information about the offer from the first vendor.

24. The system of claim 23 wherein only users registered with the server as authorized users are allowed to view, select and accept information.

25. The system of claim 24 wherein the server and at least one remote computer system are coupled together over the internet to allow the user of the remote system to view, select and accept information relating to the offer.

26. A computer program product storing instructions therein for instructing a computer to perform a method comprising the steps of: (a) providing information from a first vendor to a second vendor about items available from the first vendor that are available for inclusion within items offered by the second vendor to a consumer for purchase at retail as a virtual bundle of items; (b) providing information from the first vendor to the second vendor about an incentive offered by the first vendor to the second vendor based on the virtual bundle of items purchased by the consumer; (c) providing information about the virtual bundle of items purchased by the consumer to the first vendor and the second vendor; and (d) providing an incentive from the first vendor to the second vendor based on the virtual bundle of items purchased by the consumer; said computer program product comprising a recording medium readable by the computer and instructions stored on the recording medium instructing the computer to perform the steps (a)-(d).
